(19) United States
(12) Patent Application Publication
(10) Pub. No.: US 2003/0105697 A1
(43) Pub. Date: Jun. 5, 2003

(54) Systems and methods for rule-based lot selection of mutual funds

(76) Inventors: Theresa McGuire Griffin, Hingham, MA (US); Lisa-Marie Ardita, Holbrook, MA (US); John Andrews, Duxbury, MA (US); Barbara Donahue, Watertown, MA (US); John D. Fitch, Framingham, MA (US); John Mahoney, Middleton, MA (US)

Correspondence Address: ROPES & GRAY, ONE INTERNATIONAL PLACE, BOSTON, MA, 02110-2624, US

(21) Appl. No.: 09/999,512

(22) Filed: Oct. 25, 2001

(51) Int. Cl. G06F 17/60

(52) U.S. Cl. 705/36

(57) ABSTRACT

A computer-based system and method is disclosed that allow a custodian or fund accounting agent of a mutual fund to select lots in the portfolio inventory based on predefined rules to maximize the fund's after tax return. If no rule is stipulated, the process automatically compares tax consequences for possible combinations of buy and sell lots of a security under the various business rules and selects the rule for the particular trade that results in the most favorable tax for the fund.

### FIELD OF THE INVENTION

The systems and methods described herein include systems for managing investment portfolios and for selecting specific lots of assets to be sold based on rules to generate a desired investment return, in particular a desired after-tax return.

### BACKGROUND OF THE INVENTION

Institutional investors such as pension funds, insurance companies and mutual funds are typically long-term holders of securities. Other institutions, such as State Street Bank, act in a custodial capacity for these institutional investors. An investment manager, designated by a fund administrator, will from time to time act on behalf of its shareholders and instruct the custodian to purchase and/or sell securities for the benefit of the shareholders. Such purchases and sales typically have tax consequences, unless they are held in tax-deferred accounts, such as Individual Retirement Accounts (IRA) and 401(k) accounts.

Mutual funds are highly regulated financial entities that comply with federal laws and regulations. The U.S. Securities and Exchange Commission (SEC) regulates mutual funds under the Investment Company Act of 1940. The 1940 Act requires mutual funds to protect their portfolio securities by placing them with a custodian, most of whom are qualified banks.

The Investment Company Act of 1940 also requires the fund maintain the securities separately to protect shareholder interests. Typically, a custodian and fund accounting agent holds and accounts for the inventory of securities for its clients. Each mutual fund will hold several securities and within each security there may be several lots of that security. Each lot purchased is recorded separately with a cost basis and purchase date.

The Internal Revenue Code also places requirements upon a mutual fund under Subchapter M. A mutual fund is required to distribute virtually all of its earnings and capital gains to their shareholders in order to avoid any tax to the mutual fund itself. Thus, the income and capital gains of a mutual fund are passed through to the shareholder. Further, specific to the calculation of capital gains, the IRS specifies that the taxpayer must identify the particular shares of stocks or bonds sold. If the taxpayer cannot specifically identify the lots, they must use the basis of the securities acquired first (First in, First out, or FIFO). The administrator or investment manager, on behalf of the fund, selects the lots, or the methodology for selecting the lots held by the mutual fund, which will be coupled with the sale of the security. Historically, administrators and investment managers of mutual funds have used specific identification of security lots for different purposes—to generate higher yields and returns, or to avoid short-term capital gains.

For example, in an accounting system presently in use, several variations of specific identification costing methods are implemented that will automate lot selection when a security is sold. Exemplary methods are:

Closest to average—Lots with a price per share closest to the average cost per share are removed first from the inventory

Last in, First out (LIFO)—The most recently purchased lots are removed from the inventory first

Highest cost, First out (HCFO)—Lots, which are carried at the highest price, are removed first from the inventory.

Lowest cost, First out (LCFO)—Lots, which are carried at the lowest local price, are removed first from inventory.

First in, First out (FIFO)—The oldest purchased lots are removed from the inventory first.

As sells come into the accounting system, lots are sold using one of the above inventory costing methods. The gain/loss on each sell is then posted to the accounting system. These methodologies, hard coded into the accounting system, do not allow for the actual calculation of the tax result to be computed prior to the selection of the lot, nor do they allow for the viewing of the scenarios prior to choosing the lot. They also do not allow the user to easily change the rule as the status of the fund changes. For example, a fund whose sales transactions have resulted in a net capital loss will perhaps wish to take gains until the loss is eradicated, and then begin to apply lots that generate a loss again.

There are products available on the Internet that allow an individual investor to track his/her portfolio. These products rank the after tax impact of selling each tax-lot and assigns them a numeric value (sell grade). Sell grades are derived by considering each tax-lot's adjusted cost basis (i.e. the original cost basis adjusted for all wash sales and/or corporate actions), current holding period (i.e. long-term or short-term) and current market price, and, most importantly, the individual investor's personal tax rate and previous realized gains/losses, including the character of those gains and losses. In this way, the products' Sell Grade is customized to each individual investor's portfolio and tax situation. The individual investor would then review the sell grade and make decisions on which securities and which lots to sell based on the sell grades. This information would then be sent to their broker or financial planner for trade execution. This product is mainly a pre-trade application, meaning that the decision to sell a security is decoupled from the actual sale of a lot.

Accordingly, there remains a need for an automated method and system for executing a rule-based sale of securities, and more particularly a method and system that takes into account the tax consequences for a mutual fund or an institution that invests on behalf of individuals or other entities.

### SUMMARY OF THE INVENTION

Investment activities are frequently performed based on established rules. For example, an investor in financial instruments, hereinafter also referred to as security, which can include stocks, bonds, mortgage-backed instruments, commodities, futures and other assets of monetary value, may not only want to maximize the return on the investment, but also invest with tax consequences favorable to the investor. This applies to individual investors as well as to treasurers and administrators of investment money. Likewise, the investment may not only be in individual stocks and bonds, but may also include mutual finds. Until now, mutual funds, aside from tax exempt bond funds, have mostly been managed without taking into consideration the tax consequences for the investor(s). Accordingly, the systems and methods described herein provide tools that allow a custodian or fund accounting agent to select lots in the portfolio inventory based on predefined rules, such as rules to maximize the flind's after tax return.

According to one aspect of the invention, a computer-implemented process for allocating securities to tax-efficient trades in a mutual find includes requesting a sale of a security; selecting a business rule that applies to the sale of said security; selecting a tax rate that applies to the sale of said security; identifying at least one lot of said security that are adapted to be sold; and based on said business rule, selecting and selling at least one lot from the least one lot so as to produce the smallest tax consequence for the mutual fund. The specific security to be sold as well as the business rule and tax rate can be selected by a manager acting on behalf of shareholders of the mutual fund.

According to another aspect of the invention, a computer-implemented process for rule-based allocation of securities to trades in a mutual find includes setting an investment goal for the mutual find; defining at least one business rule compatible with the investment goal; requesting a sale of a security; identifying at least one lot of said security that are adapted to be sold; calculating for the least one lot a potential investment return; and selling those lots that produce an optimal investment return for the mutual fund consistent with the fund's investment goal.

In one embodiment, the investment goal can include minimizing the fund's tax liability or optimizing an after-tax return. The business rules can be selected from traditional rules, such as FIFO (First in, first out), LIFO (Last in, first out), HCFO (Highest cost, first out) and LCFO (Lowest cost, first out), and/or from more tax-specific rules, such as realizing the largest loss/smallest gain, executing wash sales, realizing net short term gain/net long term gain, realizing net short term loss, realizing net long term loss, and realizing largest tax loss/smallest tax gain. These rules can be applied alone or in combination, and other appropriate rules, such as custom rules or rule changes necessitated, for example, by government regulations, can be substituted and/or added. Instead of specifying a fixed rule for a sell transaction, the business rules may also be dynamically adapted by the system or process before the lots are sold while satisfying the overall investment goal for that sale. For example, if previous trades resulted in large gains (losses), a rule may be selected by the system or process that generate Losses (gains) so as to cause a favorable tax result.

In another embodiment, the process may also include an alert notification that alerts a user to a change in certain conditions, such as expiration of statutory waiting periods, and requests user feedback before lots are sold. The alarm notification can also suggest using a manual process for selling the lots.

According to yet another aspect of the invention, a computer program product is provided that includes computer executable code for identifying buy lots of a security in response to a request for a sale of a security. The product further includes computer executable code for identifying at least one lot of said security that are adapted to be sold as well as a plurality of business rules that apply to the sale of said security; based on a tax rate, code for computing a tax consequence of the sale by applying at least one of the plurality of business rules to possible combinations of the buy and sell lots before the lots are sold; and code for identifying the business rule that produces the smallest tax consequence for the mutual find from the sale of the lots.

Other uses, additions, and modifications to the systems and methods described herein will be apparent from the following description of certain illustrated embodiments.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts a system according to the invention for allocating shares of securities to be traded using a Tax Efficient Lot Selector (TELS);

FIG. 2 depicts schematically an information flow for executing a buy;

FIG. 3 depicts schematically an information flow for executing a sell using the Tax Efficient Lot Selector (TELS);

FIG. 4 is a schematic process flow diagram for executing a sell using the Tax Efficient Lot Selector in; and

FIG. 5 is a detailed flow diagram depicting the applied sell rules for tax purposes.

### DESCRIPTION OF CERTAIN ILLUSTRATED EMBODIMENTS

To provide an overall understanding of the invention, certain illustrative embodiments will now be described, including a system that allows a custodian or fund accounting agent to trade securities taking into consideration the tax consequences of such a trade. However, it will be understood by one of ordinary skill in the art that the systems and methods described herein can be adapted, added to and modified for other rule-based applications, and realized through different embodiments, and that such other applications, additions and modifications are also encompassed within the scope hereof.

As the embodiments that have been chosen to illustrate the systems and methods of the invention relate, at least in part, to tax-efficient lot selection, for purposes of clarity and illustration an example of a tax-efficient lot selection will be presented below along with a glossary of certain terms that are commonly employed when describing such a selection. However, it will be understood that the example and the terms are being provided merely for the purpose of describing the systems and methods of the invention so as to enable one of ordinary skill in the art to make and use the invention as best contemplated, and are not to be understood as limiting in any way.

In January 2001, the Securities and Exchange Commissions (SEC) adopted a rule that requires mutual funds to disclose not only total a total return, but also a standardized after-tax return for one-, five-, and ten-year periods. This change has caused funds to devise ways to make their portfolios more tax efficient, and begin to market tax efficient funds. The focus of a tax efficient mutual fund is on minimizing distributable taxable income for the purpose of maximizing the after-tax returns on the portfolio. The best way to achieve this objective is through the management of long term capital gains, which have a significantly lower federal tax rate than the tax rate on ordinary income and short term capital gains.

The invention, hereinafter referred to as Tax Efficient Lot Selector (TELS), is directed to a system and process for allocating securities for rule-based trading, and more particularly to streamlining the decision making process by providing greater flexibility in inventory costing methods as well as providing further analysis in lot selection. The application analyzes the tax consequences, using tax rates and business rules, and links the buy lots to a security sale, thereby providing a more efficient tax result to the shareholder.

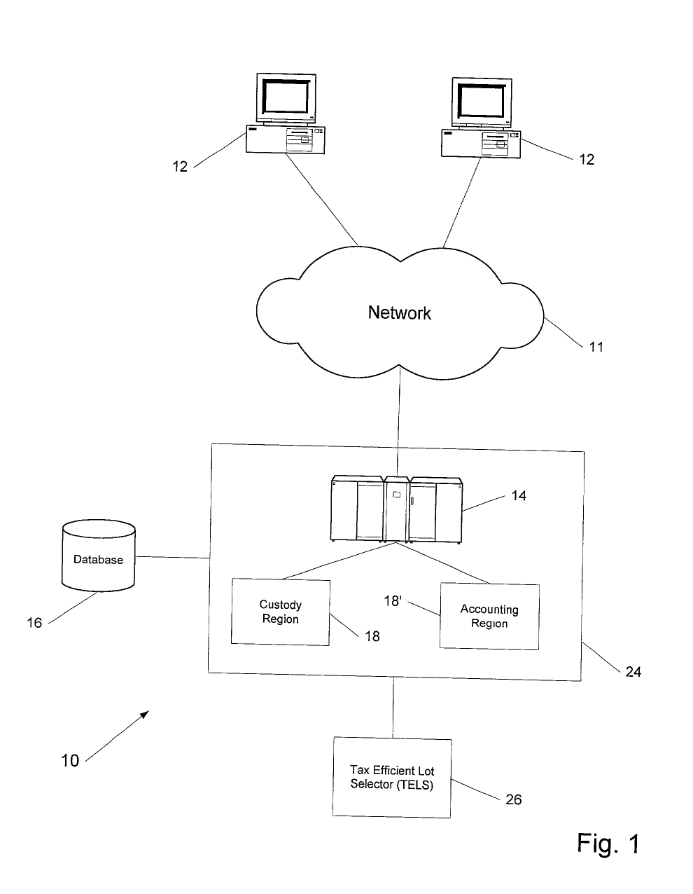

FIG. 1 depicts one embodiment of a system 10 that allows an investment manager to communicate with an administrator/custodian of a fund, for example, to execute buys and sells of securities. Specifically, FIG. 1 illustrates a system 10 wherein a plurality of clients 12 representing, for example, different investment managers connect through a network 11 to a server 14 of the administrator/custodian. The server 14, which depending on the application can be a general purpose and/or mainframe computer, connects to a proprietary database 16 maintained by the server 14. The server 14 similarly connects to, or may include, systems 18, 18′ referred to as Custody Region 18 and Accounting Region 18′, respecticely, which may be implemented in hardware and/or in software and can process transactions associated with Portfolio Accounting and Record Keeping. The server 14 together with the Custody Region 18 and Accounting Region 18′ will be referred to in the present embodiment as Custody and Accounting System (State Street name: “Horizon”) 24. The Custody and Accounting System 24 supports the activities consistent with securities processing procedures, i.e. trading and settling securities, controlling cash and security movement and provides full general ledger accounting, historical record keeping of all transactions and holdings, as well as a variety of reporting options on an individual client/fund basis. Within each region, there are different edit checks that are performed for completeness and accuracy.

The Custody and Accounting System 24 is also connected to an application 26 referred to as the Tax efficient Lot Selector (TELS) which may be implemented in hardware and/or software. The Tax Efficient Lot Selector 26 supports the server 14 in analyzing the trade-related issues that arise for a particular investment manager when participating in a sell of securities. The role of the TELS will be described in detail below. It will be understood that although the TELS 26 is shown as being separate from the Custody and Accounting System 24, it can also be integrated therewith, for example, as an application program run by the server 14. The elements of the system 10 may include commercially available systems that have been arranged and modified to act as a system according to the invention. The depicted system 10 of FIG. 1 may employ traditional point-to-point connections or the depicted network 11, such as the Internet, to allow an investment manager at a remote client 12 to access a central server, the depicted central server 14, to login to an account maintained by that server 14, and to employ the services provided for that account to effect buying/trading/selling of securities held by the custodian and to analyze the tax impact when trading those securities.

For the depicted system 10, the subscriber systems 12 may be any suitable computer system such as a PC workstation, a set top box, a handheld computing device, a wireless communication device or any other such device equipped with a network client capable of accessing a network server and interacting with the server to exchange information with the server. In one embodiment, the network client is (i) a web client, such as the Netscape web browser, the Microsoft Internet Explorer web browser, the Lynx web browser, or a proprietary web browser, or (ii) a client application that allows the user to exchange data with a web server, ftp server, gopher server or some other type of network server. Additionally, in certain other embodiments the systems and methods described herein can include server systems that also act as clients for interacting with the server 14. In these embodiments, the server systems can support an institution or other entity that may have a substantial number of financial institutions and/or custodians that could benefit from the services provided by the server 14.

As mentioned above, the client and the server may rely on an unsecured communication path, such as the Internet, for accessing services on the remote server 14. To add security to such a communication path, the clients 12 and the server 24 may employ a security system, such as any of the conventional security systems that have been developed to provide to a remote user a secured channel for transmitting data over the Internet. One such system is the Netscape secured socket layer (SSL) security mechanism that provides to a remote user a trusted path between a conventional web browser program and a web server. Therefore, optionally and preferably, the clients 12 and the server system 14 have built in 128 bit or 40 bit SSL capability and can establish an SSL communication channel between the clients 12 and the server 14. Other security systems can be employed, such as those described in Bruce Schneir, Applied Cryptography (Addison-Wesley 1996). Alternatively, the systems may employ, at least in part, secure communication paths for transferring information between the server 14 and the clients 12. For purpose of illustration, however, the systems described herein, including the system 10 depicted in FIG. 1, will be understood as employing a public channel, such as an Internet connection through an ISP or any suitable connection, to connect the subscriber systems 12 and the server 14.

The server 14 may be supported by a commercially available server platform such as a Sun Sparc™ system running a version of the Unix operating system and a server program capable of connecting with, or exchanging data with, one of the clients 12. In the embodiment of FIG. 1, the server 14 can include a web server, such as the Apache web server. The web server component of the server 14 listens for requests from clients 12 and, in response to such a request, resolves the request to identify a filename, or script, that can be associated with that request and to return the identified data to the requesting client 12. The operation of the web server component of the server 14 can be understood more fully from Laurie et al., Apache The Definitive Guide, O'Reilly Press (1997). The server 14 may also include components that extend its operation to accomplish the financial transactions and processes described herein, and the architecture of the server 14 may vary according to the application. For example, the web server may have built in extensions, typically referred to as modules, to allow the server 14 to perform operations that facilitate the transactions and analysis desired by a client, or the server 14 may have access to a directory of executable files, each of which may be employed for performing all or part of the operations, that implement the processes described herein.

The depicted database 16 may comprise any suitable database system, including the commercially available Oracle® FAMIS™ database, and can be a local or distributed database system. The design and development of database systems suitable for use with the system 10, follow from principles known in the art, including those described in McGovern et al., A Guide To Sybase and SQL Server, Addison-Wesley (1993). The database 16 can be supported by any suitable persistent data memory, such as a hard disk drive, RAID system, tape drive system, floppy diskette or any other suitable system. The system 10 depicted in FIG. 1 includes a database 16 that is separate from the server 14. However, it will be understood by those of ordinary skill in the art that in other embodiments the database 16 can be integrated into the server 14.

The Tax Efficient Lot Selector application is a straight-through process that provides rules based analysis to couple the sale of a security already executed by find's investment manager with the lot in the portfolio inventory that creates the most tax efficient result. The application sends the selected lot to the accounting system to complete the detailed general ledger postings required by the completed transaction. The application's built in flexibility allows the client to use a set of pre-defined rules or the client can specify their own rule to be utilized in the application. The application also allows the use of differing tax rates in the calculation based on the client's knowledge of the rates that should apply to their shareholder base.

Rules can be customized based on a find's position. For example, if a fund is in a gain position, it may want to select lots that would generate losses to offset those gains. As a find's position changes, the rules can change to meet the need of the fund.

The TELS can be executed using the following exemplary business rules:

TABLE 1

| Business Rule | Formula |
|---|---|
| Rule A | Largest loss/smallest gain |
| | Sell ST loss (largest to smallest cost) |
| | Sell LT loss (largest to smallest cost) |
| | When all loss lots have been sold, calculate after tax gain |
| | amount |
| | Sell gain lots in order lowest tax |
| Rule B | Wash sale exists |
| | 1) Skip selling loss lots |
| | 2) Sell gain lots first, based on which would generate the |
| | smallest tax (i.e. 39.6% vs. 20% vs. 10%) |
| | 3) After all gain lots have been sold, begin selling loss |
| | lots. Generally there should be ST losses only since it |
| | was identified that this is a wash sale. |
| Rule C | Net realized short term gain or net realized long term |
| | gain |
| | 1) Realize the lot(s) that generate the largest short-term |
| | tax loss per share |
| | 2) Realize the lot(s) that generate the largest long-term |
| | tax loss per share |
| | 3) Realize the lot(s) that generate the smallest tax gain |
| | per share, regardless of duration |
| Rule D | Net realized short-term loss |
| | Realize largest short-term gains, up to the amount of |
| | short-term loss |
| | Realize largest long-term gains, up to the amount of |
| | short-term losses |
| | Realize largest short-term loss |
| | Realize largest long-term loss |
| Rule E | Net realized long-term loss |
| | Realize largest short-term gain, up to the amount of the |
| | long-term losses |
| | Realize largest long-term gain, up to the amount of |
| | long-term losses |
| | Realize largest short-term losses |
| | Realize largest long-term losses |
| Rule F | Largest tax loss/smallest tax gain |
| | Realize the lot(s) that generate the largest tax loss per |
| | share, regardless of duration |
| | Realize the lot(s) that generate the smallest tax gain per |
| | share, regardless of duration |
| Rule G | This rule gives the user the flexibility to order long term |
| | and short term gains and losses any they would like. The |
| | user may want the ability to do this by utilizing the tax |
| | rate as well. |

The term ST (short term) loss and LT (long term) loss are defined by the U.S. Tax Code and apply to securities held for less than 1 year and more than 1 year, respectively. A Wash Sale occurs when any security (including options) are purchased with 30 days of a loss incurred from the sale of any substantially identical security. The contract to purchase a substantially similar security may be entered into 30 days prior to, or subsequent of, the sale (61 days total). The amount of the loss is disallowed for tax purposes. Additional details are described in the “Alert notification routines” discussed below.

The client can determine which short-term and which long-term rate is to be applied to both the gain and the loss. The gain and the loss tax rate may be the same unless the client indicates otherwise. Moreover, the client can also determine which of the agreed exemplary business rules listed in Table 1 should be applied to determine the lots to be sold with the most efficient tax consequences. Business rule or tax rate updates can be done through a one time setup or can change as frequently as daily. For example such changes may be implemented at the end of the fiscal year or during the excise tax period. Alternatively, by calculating hypothetical trade results using all the above business rules for the lots that can be sold, the TELS process may determine the most advantageous business rule to apply and execute the trades accordingly.

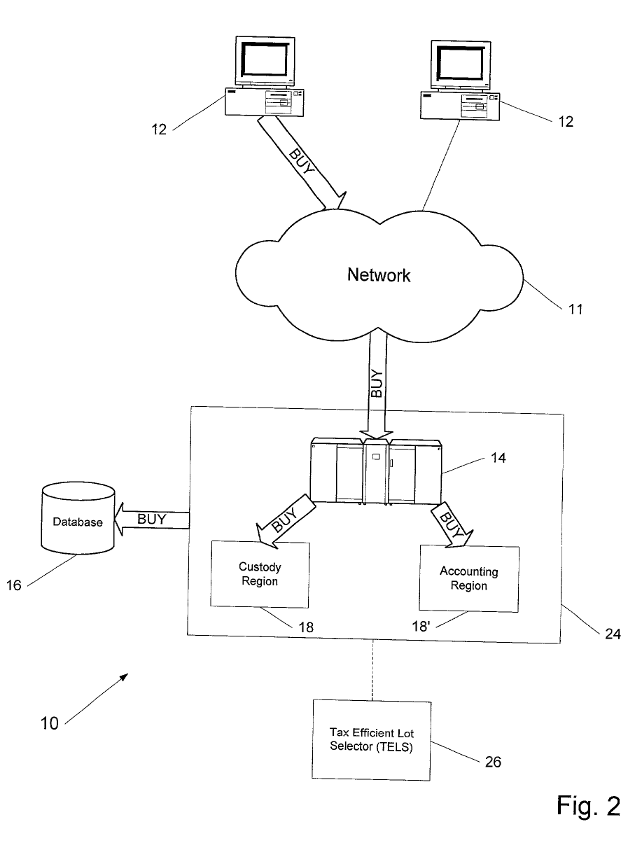

FIG. 2 depicts schematically the flow of information from a client 12 to the custody and accounting system 24 when executing a buy. The buy transaction information is indicated in FIG. 2 by arrows “BUY”; this information is received by the custodian's system 24 and sent into the custodian's mainframe custody and accounting system (e.g., State Street Bank's “Horizon”) 24. Trades are sent into the main database 16 and recorded in the custody region 18 and the accounting region 18′. For added data security and robustness, transactions are synchronized at various points throughout the day as well as through a detailed synchronization overnight. At this point in the trade process, the Tax Efficient Lot Selector (TELS) 26 is not involved, as indicated by the dotted line in FIG. 2.

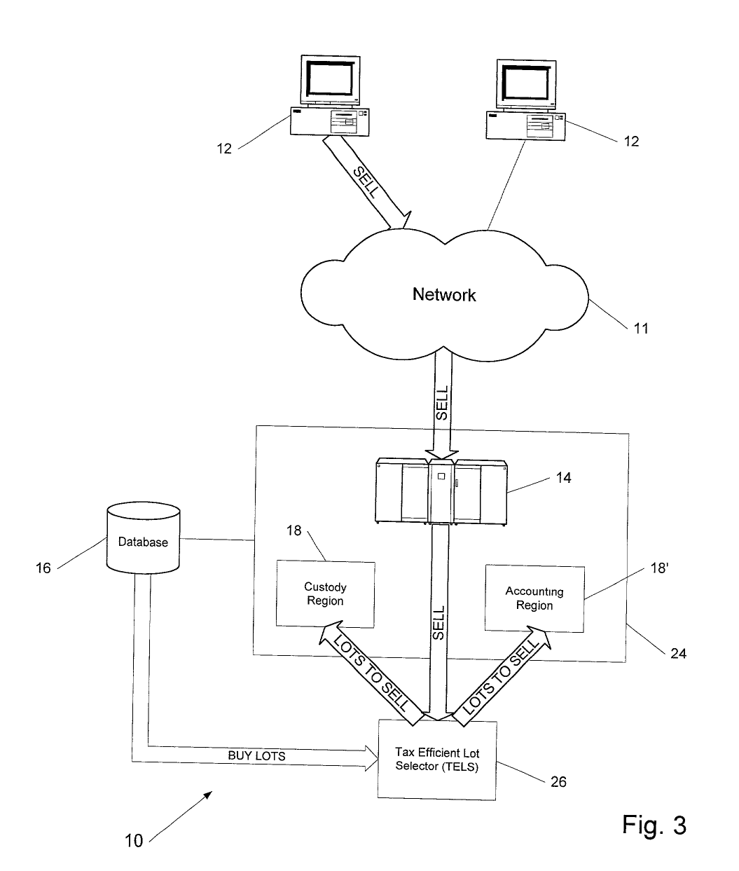

FIG. 3 depicts schematically the flow of information for executing a sell. Sell transactions are received from a client 12 into the custodian's system 24. The custodian accountant will take the authorization and update the application with the information chosen by the client. Like in the buy instruction flow described above with reference to FIG. 2, the sell instruction flow is indicated in FIG. 3 by arrows “SELL”; this trade information is sent into the custodian's mainframe custody and accounting system 24. When the sell is sent to the custody and accounting system 24, the Tax Efficient Lot Selector (TELS) 26 is connected to the server 14. In other words, for a sell, the server 14 no longer communicates directly with the database 16 and the custody and accounting regions 18, 18′, respectively, but only through the TELS 26. Once the trade is recognized in the Tax Efficient Lot Selector (TELS) application 26, the database 16 sends all the associated buy lots applicable to the specific sell to the Tax Efficient Lot Selector 26, as indicated by arrow “BUY LOTS”. Using the business rules and tax rates set up by the client 12 or dynamically, which will be described in detail below, the Tax Efficient Lot Selector 26 determines which lots to sell and then posts the sell trade with the associated lots (as indicated by arrows “LOTS TO SELL”) from the portfolio inventory to the custody region 18 and the accounting system 18′. The accounting system 18′ then calculates the gain/loss and posts the trade to the general ledger. The custody region 18 can maintain records of the trades.

In general, the client can have the option of processing trades automatically through the TELS application or stopping the trades to view and push through manually. Tax rates can be determined by the client and set up in the application. Current IRS tax rates can be utilized or the application can take a blended rate, as specified by the client. Business rules can be set up in the application as specified by the client and/or automatically set up in the application, step 17, which means that business rules can be changed as the find status changes. The application also has functionality to selectively stop transactions from processing by flagging a specific security, for example, based on the security's CUSIP number, and setting a date range, as described in more detail below. The client can also authorize changes in the fund's set-up.

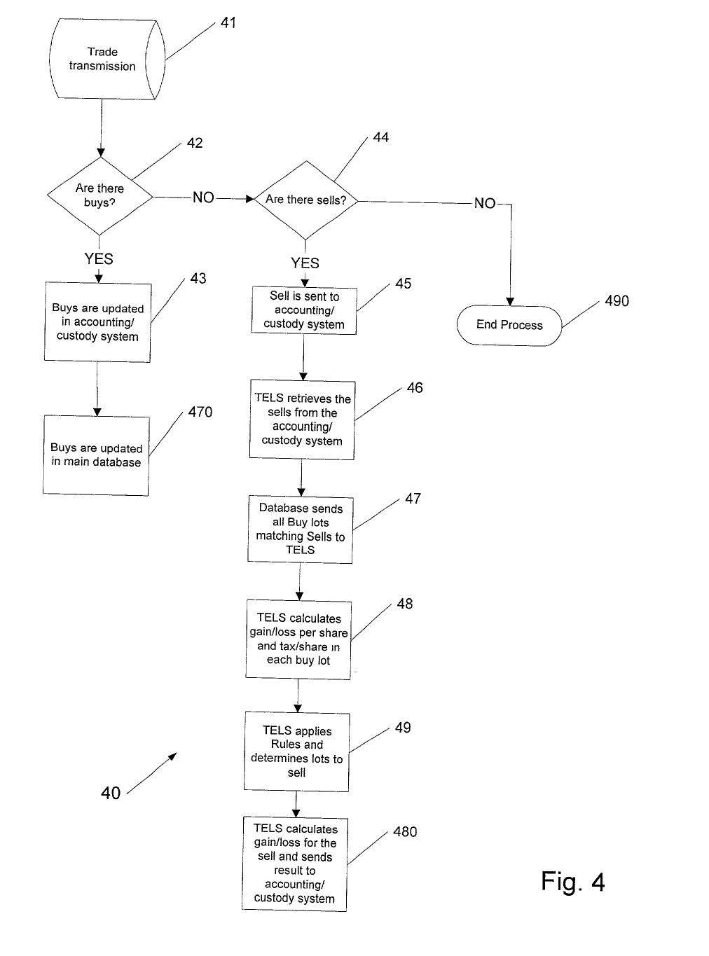

FIG. 4 shows a process flow 40 involving the Tax Efficient Lot Selector in a sell. As described already with reference to FIGS. 2 and 3, the a buy or sell order (trade) is transmitted electronically to the custodian, step 41. It is first determined if the trade is a buy, step 42, in which case the buys are updated in the accounting system and in the main database, respectively, steps 43 and 470. On the other hand, if the trade is a sell, step 44, then the sell transactions are sent to the accounting system and held until the Tax Efficient Lot Selector retrieves the transactions, step 45. The TELS application retrieves all applicable buy lots for that security from the main database, step 46, while the database sends all buy lots of those securities that match the sell lots, to the Tax Efficient Lot Selector TELS, step 47. TELS calculates the gain/loss and tax per share for each buy lot, step 48. Using the business rules selected, for example, from Table 1, the application determines which lot(s) to sell, step 49. The selected lots are then posted back to the mainframe system 24 to calculate the gain/loss and post the results to the fund's accounting/custody system, step 480. If there are no buys or sells, the process will not execute and terminate at step 490.

The application can be used by both the custodian and the client.

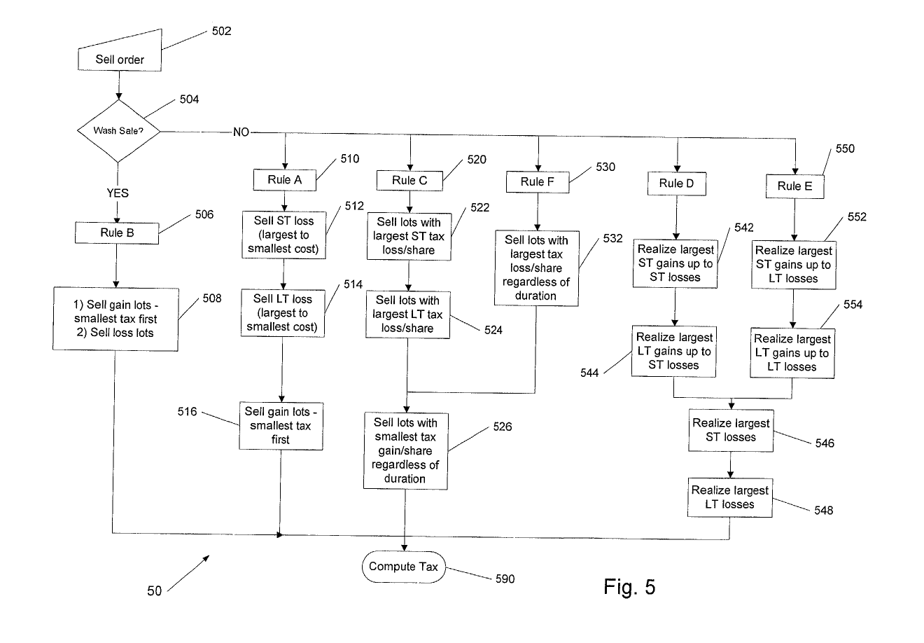

FIG. 5 is a detailed flow diagram of step 50 of FIG. 4 showing the execution of a trade based on the agreed business rules (Rule A through F in Table 1). Rule G remains open for client customization and will not be discussed. The TELS application computes the tax liability for the business rule that is being applied. Alternatively or in addition, the TELS can determine which business rule would generate the least amount of taxes, if the business rule was not already specified by the administrator.

The operation of the TELS will now be described with reference to specific examples. It will be assumed that in June 2000 the fund sells 200 shares of IBM stock out of five buy lots with 100 shares each having the following base price:

TABLE 2

| | | | | | Gain/ | Tax rate per |
|---|---|---|---|---|---|---|
| | | | | Holding | Loss | share |
| | No. of | | Purchase | Period | per | ST = 39.6% |
| Lot | Shares | Buy Date | Price | (Gain/Loss) | Share | LT = 20% |
| A | 100 | 6/00 | $102 | ST (Loss) | <$2> | <$0.79> |
| B | 100 | 5/00 | $99 | ST (Gain) | $1 | $0.396 |
| C | 100 | 12/99 | $65 | ST (Gain) | $35 | $13.86 |
| D | 100 | 4/99 | $96 | LT (Gain) | $4 | $0.80 |
| E | 100 | 3/98 | $105 | LT (Loss) | <$5> | <$1.00> |

Upon receipt of a sell order, step 502, the TELS determines if there would be a wash sale, step 504. As seen from Table 2, only lot A produces a wash sale.

If the administrator is using Rule B, step 506, and a wash sale occurs (as in this case), the lots that generate a loss will be avoided in compliance with the IRS rules. Gain lots that produce the lowest tax would be sold first, with loss lots being sold only after all gain lots are sold, since tax losses cannot be realized in a wash sale, step 508. In this example, the Tax Efficient Lot Selector (TELS) would select lots B and D for a tax impact of $119.60. This rule would only be used for funds that adjust their cost basis for wash sales. Funds that keep this information in a tax ledger may not utilize this rule.

For the remainder of the Rules, unless stated otherwise, it is assumed that in September 2000 the fund sells 300 shares of IBM stock out of five buy lots with 100 shares each having the above base price. If Rule A is selected, step 510, shares producing a ST loss are sold first, from largest to smallest cost, step 512. Thereafter, shares producing a LT loss are sold, also from largest to smallest cost, step 514. After all loss lots are sold, the gain lots are sold in the order from lowest to highest tax liability, step 516, with the total tax being computed in step 590. In this example, the tax efficient application TELS should choose lots A, B, & E to sell, resulting in a tax credit of <$139.40>.

When applying Rule C (“Net realized short term gain or net realized long term gain”), step 520, the lot(s) that generate the largest short-term tax loss per share are realized first, step 522. Thereafter, the lot(s) that generate the largest long-term tax loss per share are realized, step 524. Finally, the lot(s) that generate the smallest tax gain per share, are realized regardless of duration, step 526, with the total tax again being computed in step 590. In this example, the tax efficient application should choose lots A, B, & E to sell, resulting in the same tax credit of <$139.40> as for Rule A.

When applying Rule F, step 530, the lot(s) that generate the largest tax loss per share regardless of duration are realized first, step 532. Since only two lots (A and E) show tax losses, these lots are sold. Thereafter, as under Rule C, the lot that generates the smallest tax gain per share regardless of duration is realized (lot B), step 526, with the total tax again being computed in step 590. In this example, the tax efficient application should choose lots A, B, & E to sell, resulting in the same tax credit of <$139.40> as for Rules A and C.

When applying Rule D (“Net realized short-term loss”), step 540, the lot(s) that generate the largest short-term gains up to the amount of the net short-term losses are realized first, step 542. The net short term loss refers to the funds overall gain/loss position during the tax year. As securities are sold, the find's gain/loss position increases or decreases depending on what each individual security sells at. Because tax is only paid at the end of the year, securities that are sold at a gain at the beginning of the year, can be offset by the losses incurred later in the tax year. By doing this, the overall tax paid at the end of the year, can be greatly reduced. IRS rules also allow the tax payer to carry forward any losses that have not been offset by the gains for that year. The largest short term gains are lots B and C. Thereafter, the lot(s) that generate the largest long-term gains up to the amount of short-term losses are realized, step 544. This is followed by the realization of the largest ST losses, step 546. Finally, the lot(s) that generate the largest long-term losses are realized, step 548, with the total tax being computed in step 590. In this example, the tax efficient application should choose lots B, C & D to sell, resulting in a tax liability of $1,505.60.

When applying Rule E (“Net realized long-term loss”), step 550, the lot(s) that generate the largest short-term gains up to the amount of the net long-term losses are realized first, step 552. These are lots B and C. Thereafter, the lot(s) that generate the largest long-term gains up to the amount of long-term losses are realized, step 554. This is followed by the realization of the largest short-term losses, step 546. Finally, the lot(s) that generate the largest long-term losses are realized, step 548, with the total tax once more being computed in step 590. In this example, the tax efficient application should choose lots B, C & D to sell, resulting in a tax liability of $1,505.60 as under Rule D.

Aside from the aforedescribed Rules A-F applied by TELS, as mentioned before, other generally accepted costing rules T4-T8 listed below in Table 3 can also be applied, such as:

TABLE 3

| | Rule | |
|---|---|---|
| T4 | Closest to average | Purchase lots with a base price per |
| | | share closest to the average cost |
| | | per share are sold first |
| T5 | First-In-First-Out (FIFO) | The oldest purchase lots are sold |
| | | first in trade date order leaving the |
| | | most recent lots in inventory |
| T6 | Last-In-First-Out (LIFO) | The most recent purchase lots are |
| | | sold first in trade date order |
| | | leaving the oldest lots in inventory |
| T7 | Highest-cost, First-Out (HCFO) | Purchase lots with the highest base |
| | | price are sold first |
| T8 | Lowest-cost, First-Out (LCFO) | Purchase lots with the lowest base |
| | | price are sold first |

If no holding period is specified, then the above costing methods will be applied without restriction. Conversely, if a holding period is selected in conjunction with the Rules T4-T8, then long-term lots are sold first within the holding period, followed by short-term lots within the holding period. These conventional rules do not contribute to tax-efficient lot selection.

Applying the additional Rules T4-T8 to the Buy Lots listed in Table 2 targets the following lots (listed in Table 4) to be selected if the Fund sells 200 shares in September 2000 at a cost of $100 per share:

TABLE 4

| Rule | Lots selected (in that order) |
|---|---|
| T4 | D and E (Holding period YES); D and B (Holding period NO) |
| T5 | E and D (Holding period YES); E and D (Holding period NO) |
| T6 | D and E (Holding period YES); A and B (Holding period NO) |
| T7 | E and D (Holding period YES); E and A (Holding period NO) |
| T8 | D and E (Holding period YES); C and D (Holding period NO) |

The application also provides the user an alert notification tool that can operate, for example, through the user's existing email. The alert tool notifies the user when specific conditions are not met, by sending a message to the user's desktop. For example, an alert may notify the user when a short term buy lot is close to becoming a long term buy lot. This may be used when making decisions on which business rule to use, as short term rates are significantly higher than long term rates. Other alerts will notify the user that a particular security has been sold. This may be necessary as there are cost adjustments for tax purposes that may not be reflected on the application and the user would rather use a different rule when selecting lots. Additional alerts would indicate when the fiscal year end and the excise year end are approaching. As these dates approach, the administrator of the find may decide to change their inventory costing method to achieve a different tax result.

The alerts may respond to the following conditions and incorporate the following messages listed in Table 5 below:

TABLE 5

| # | Alert | Description | Additional information | Timing |
|---|---|---|---|---|
| 1 | CUSIP #, security | Alert identifies when a | Current date - Lot purchase | When TD is |
| | name, lot # is a X | short term gain or loss | date < X days; Default is 30 | greater than |
| | days from | is close to becoming a | days but is flexible enough | 335 (336 leap |
| | becoming a long | long term gain or loss | to change for client | year) days |
| | term gain or loss | | specifics (located in fund | from current |
| | (include TD, | | configuration screen). | date. This day |
| | shares, cost) | | Upper limit is 365 days | would change |
| | | | (leap year) 364 days in non | if default is |
| | | | leap year. Lower limit is | different from |
| | | | 1 days. | 30. |
| 2 | CUSIP #, lot # is 30 | Alert identifies when a | Current date - lot purchase | When TD is |
| | days from | long term gain or loss | date < 30 days default to an | greater than |
| | becoming a long | is close to becoming a | agreed upon day by the | 1795 (1796 |
| | term 5 gain or loss, | long term gain or loss. | users and be flexible | leap year) |
| | Include trade date, | | enough to change for client | days from |
| | shares, & cost in | | specifics (located in fund | current date. |
| | description. | | configuration screen). | This day |
| | | | Upper limit is 1,827 days | would change |
| | | | (leap year) 1,825 days in | if default is |
| | | | non leap year. Lower limit | different from |
| | | | is 365 days. | 30. |
| 3 | CUSIP X needs to | Alert identifies when | | As the trade is |
| | be manually | the user is in | | brought into |
| | processed because | automode, but a CUSIP | | application |
| | it is flagged | has been flagged to | | |
| | | manually process and | | |
| | | has entered the | | |
| | | application to be sold. | | |
| 4 | Flagged CUSIP is | Alert identifies when a | Current date - CUSIP | When current |
| | expiring in X days | CUSIP has been | expiration date ≦ 5 days | day equals |
| | | selected as manual and | Default to an agreed upon | (expiration |
| | | is X days from | day by the users and be | date - 5 |
| | | expiration dates. | flexible enough to change | business days) |
| | | | for client specifics. If the | (the 5 days |
| | | | filtered period is under (1) | may be |
| | | | days, do not send user alert. | adjusted by |
| | | | | user) |
| 5 | Tax Rates have | Alert to notify user that | Use comment field from | When the user |
| | changed from rule | tax rate X has changed | fund configuration screen | makes |
| | X to rule Y by user | to Y because | and user ID. This is a | changes in the |
| | ID X. and/or | (description from | mandatory screen. All | fund |
| | Business Rule has | configuration screen) | fields must be populated. | configuration |
| | been changed from | by user I D X. Alert to | | screen to rates |
| | rule X to rule Y by | notify user that | | |
| | user Id X | business rule X has | | |
| | | changed to Y because | | |
| | | (description from | | |
| | | configuration screen) | | |
| | | by user ID X. | | |
| 6 | CUSIP X needs to | Alert to notify user that | Logic to be determined by | As the |
| | be posted to MCH | trades have not been | developers. For example, | transaction |
| | (include td, shares, | processed through | the trade is waiting to be | occurs |
| | cost in description) | application | processed in application. | |
| | error reason. | | | |
| 7 | Fiscal year end is | Alert to notify user that | Current date - fiscal year | When fiscal |
| | 15 days away | fiscal year end on the | end ≦ 15 days (default). | year end = |
| | | fund is X days away | User require the flexibility | (current day - |
| | | | to change for client | 15) (the 15 |
| | | | specifics (located in fund | days may be |
| | | | configuration screen). | adjusted by |
| | | | | user) |
| 8 | Excise is 15 days | Alert to notify user that | Current date - excise period | When excise |
| | away | excise period on the | 10/31 ? <= 15 days. Users | year end = |
| | | fund is X days away | require the flexibility to | (current day - |
| | | | change for client specifics | 15) (the 15 |
| | | | (located in fund | days may be |
| | | | configuration screen). | adjusted by |
| | | | | user) |

It will be understood by those skilled in the art that the Rules described above most likely do not apply to securities held in tax-deferred accounts, such as 401(k) plans or IRAs. In fact, under those conditions, the reverse of the above Rules may be applied.

Those skilled in the art will know or be able to ascertain using no more than routine experimentation, many equivalents to the embodiments and practices described herein. For example, other rules may be added to or substituted for the exemplary tax rules described above. As an example, a mutual fund may have charitable goals and may want to maximize the benefits to the charity while at the same time maximizing the tax benefit for the donor. Accordingly, it will be understood that the invention is not to be limited to the embodiments disclosed herein, but is to be understood to be interpreted as broadly as allowed under the law.

We claim:

1. A computer-implemented process for allocating a lot of a security in a mutual fund trade, comprising:
requesting a sale of the security;
selecting a business rule that applies to the sale of the security;
selecting a tax rate that applies to the sale of the security;
identifying at least one lot of the security that are adapted to be sold; and
based on said business rule, selecting and selling at least one of the identified lots so as to produce the smallest tax consequence for the mutual fund.

2. The process of claim 1, wherein the security is selected from the group consisting of stocks, bonds, futures, commodities, and mortgage-backed instruments.

3. A computer-implemented process for rule-based allocation of a lot of a security to trades in a mutual fund, comprising:
setting an investment goal for the mutual fund;
defining at least one business rule compatible with said investment goal;
requesting a sale of the security;
identifying at least one lot of the security that is adapted to be sold;
calculating for the at least one lot a potential investment return; and
selling those lots of the at least one lot that produce an optimal investment return for the mutual fund consistent with the fund's investment goal.

4. The process of claim 3, wherein the investment goal is minimizing the fund's tax liability.

5. The process of claim 3, wherein the investment return is an after-tax return.

6. The process of claim 3, wherein the at least one business rule is selected from the group consisting of Largest loss/smallest gain, Wash sales, Net Realized short/long term gain, Net Realized short term loss, Net Realized long term loss, and Largest tax loss/smallest tax gain.

7. The process of claim 3, further comprising before selling the lots:
issuing an alert notification to a user, and
receiving feedback from the user.
selling the lots based on the feedback from the user.

8. The process of claim 7, wherein the alarm notification includes suggesting a waiting period before selling the lots.

9. The process of claim 7, wherein the alarm notification includes suggesting a manual process for selling the lots.

10. The process of claim 3, wherein the investment goal is set by a user.

11. The process of claim 3, wherein the at least one business rule is selected by the user prior to requesting the sale of the security.

12. The process of claim 3, wherein the at least one business rule is dynamically adapted before selling the lots so as to satisfy the investment goal of the mutual fund.

13. The process of claim 12, wherein the business rule is dynamically adapted based on investment results for previously executed trades.

14. A computer-implemented process for allocating securities to tax-efficient trades in a mutual find, comprising:
receiving user input requesting a sale of a security;
identifying buy lots of the security;
selecting a tax rate that applies to the sale of said security;
identifying at least one lot of said security that are adapted to be sold;
identifying a plurality of business rules that apply to the sale of said security;
computing a tax consequence of the sale by applying at least one of the plurality of business rules to possible combinations of the buy and sell lots before the lots are sold;
identify the business rule that produces the smallest tax consequence for the mutual fund from the sale of the lots; and
selling the lots by applying the identified business rule.

15. A computer program product comprising:
computer executable code for identifying buy lots of a security in response to a request for a sale of a security;
computer executable code for identifying at least one lot of said security that are adapted to be sold;
computer executable code for identifying a plurality of business rules that apply to the sale of said security;
computer executable code for, based on a tax rate, computing a tax consequence of the sale by applying at least one of the plurality of business rules to possible combinations of the buy and sell lots before a lot is sold; and
computer executable code for identifying the business rule that produces the smallest tax consequence for the mutual fund from the sale of the lot or lots.

16. A web-based system for allocating a security to a trade in a financial transaction, comprising
a client with a user interface that allows a user to select an investment goal of the fund and at least one business rule compatible with said investment goal, and to request a sale of a security,
a database having a history of at least one buy transaction of the security, and
a server that receives the client's request and employs the history of the at least one buy transaction to process the sales request using the at least one business rule, thereby selecting at least one lot of said security that is adapted to be sold consistent with the fund's investment goal.
